(19) United States
(12) Patent Application Publication
(10) Pub. No.: US 2026/0148675 A1
(43) Pub. Date: May 28, 2026

(54) CONCURRENT DISPLAY PIXEL PROCESSING WITH LATE STAGE CAC AND ANTI-AGING CORRECTION

(71) Applicant: QUALCOMM Incorporated, San Diego, CA (US)

(72) Inventors: Chun WANG, Markham (CA); Sreekanth MODAIKKAL, Bangalore (IN); Shresth GUPTA, Puranpur (IN); Ajaykumar Sitaram MAURYA, Bangalore (IN); Gary Arthur CIAMBELLA, Newmarket (CA); Kumar SAURABH, Bangalore (IN)

(21) Appl. No.: 18/957,296

(22) Filed: Nov. 22, 2024

(51) Int. Cl. G09G 3/20; G06T 1/20; G06T 5/73

(52) U.S. Cl. CPC G09G 3/2092; G06T 1/20; G06T 5/73; G09G 2320/0242; G09G 2320/0257; G09G 2320/046; G09G 2320/0666; G09G 2360/06; G09G 2370/16

(57) ABSTRACT

is described. An apparatus is configured to blend a first portion of image data and a second portion of image data based on / associated with foveated blending to generate blended image data. The apparatus is configured to adjust the blended image data based on/associated with CAC to generate adjusted blended image data. The apparatus is configured to output the adjusted blended image data for a display panel.

### TECHNICAL FIELD

The present disclosure relates generally to communication systems, and more particularly, to techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for display processing may utilize single operations to for image improvement, such as foveated blending or chromatic aberration correction (CAC), but may not address concurrent operations. In such techniques, color aberration and blurring occurs due to processing limitations. There is a need for improved techniques for concurrent display pixel processing with detail enhancement prior to CAC such that image data is blended, enhanced, and adjusted with CAC prior to display.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a display, a memory; and a processor coupled to the memory and the display, where based on information stored in the memory, the processor is configured to: blend a first portion of image data and a second portion of image data in accordance with foveated blending to generate blended image data, to adjust the blended image data in accordance with chromatic aberration correction (CAC) to generate adjusted blended image data, and to output the adjusted blended image data for a display panel.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating foveated blending of image data portions.

FIG. 5 is a diagram illustrating color aberration and chromatic aberration correction (CAC) of images.

FIG. 6 is a diagram illustrating CAC of images.

FIG. 7 is a diagram illustrating dual-path foveated blending of image data portions for concurrent display pixel processing with late stage CAC in accordance with one or more techniques of this disclosure.

FIG. 8 is a diagram illustrating dual-path CAC of images with inputs from the dual-path foveated blending in FIG. 7 for concurrent display pixel processing with late stage CAC in accordance with one or more techniques of this disclosure.

FIG. 9 is a diagram illustrating an architecture for concurrent display pixel processing with late stage CAC in accordance with one or more techniques of this disclosure.

FIG. 10 is a diagram illustrating an architecture for concurrent display pixel processing with anti-aging and late stage CAC in accordance with one or more techniques of this disclosure.

FIG. 11 is a diagram illustrating an architecture for concurrent display pixel processing with late stage CAC and anti-aging in accordance with one or more techniques of this disclosure.

FIG. 12 is a diagram illustrating data flows for concurrent display pixel processing with late stage CAC and anti-aging in contrast to a data flow for non-concurrent display pixel processing in accordance with one or more techniques of this disclosure.

FIG. 13 is a call flow diagram illustrating example communications between a display processor and a display panel in accordance with one or more techniques of this disclosure.

FIG. 14 is a flowchart of a method of wireless communication.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the terms “foveated blending,” “foveation blending,” etc., generally, may refer to image processing techniques by which high resolution fovea image data is positioned of over low resolution periphery image data, and “blending based on foveated blending” may refer to a blending of portions of data for an image that differ in resolution between fovea and periphery regions, which may generate a “blended output.” As used herein, the term “adjusting based on CAC” may refer to a pre-processing image correction algorithm(s) in an application processor that may be performed in a digital domain and that includes \from lens refraction. As used herein, the term “detail enhancement (DE)” may refer to image processing techniques by which image sharpness is increased and/or image edge details are amplified. As used herein, the term “aging” may refer to a set or area of pixels/subpixels in which the pixels/subpixels are experiencing aging effects such as burn-in, image retention, static content burning, display long term brightness spatial inconsistency, mura, and/or the like, and “demura” may refer to one or more processes by which pixel-to-pixel response variability of a display panel is corrected, such as in sub-pixel formats and/or non-sub-pixel format. As used herein, the term “sub-pixel rendering (SPR)” may refer to rendering techniques that create appropriate patterns of pixels, for direct display of the data onto a display panel, that includes taking pixel-aligned red (R), green (G), and/or blue (B) data from the input and down-sampling either one of the color components to create the output data. As used herein, the term “lens” may refer to a lens of a wearable device and/or display for presentation of graphical content to a user(s), such as but without limitation, a headset, a mobile device display, extended reality (XR) display glasses, an automotive display, etc., where the lens comprises a transmissive optical material(s) to focus light by refraction for viewing by a user(s). As used herein, the terms “display” and “display panel” may also generally refer to aspects of wearable devices for presentation of graphical content via a lens/lenses to a user(s).

Devices for rendering images, such as XR devices, may perform operations before rendering image data to a display panel/display, e.g., foveation/foveated blending or CAC. The fovea is the region of a lens, e.g., a lens (or lenses) of a display (e.g., a mobile device display, XR display glasses, an automotive display, etc.), where the eye focuses and the remaining portion of the region is the periphery. Foveation blending may include the positioning of the high resolution fovea over the low resolution periphery. In devices, such as XR devices, the periphery image portion may go through upscaling in video graphics (ViG/ViGViG) processing pipelines and the fovea image portion may pass through a DMA pipe unscaled. After upscaling, the periphery image portion may be blended with the high resolution fovea image portion inside a layer mixer (LM). The composed image may then pass through detail enhancer (DE) to make the image crisp. Finally, the image may be scaled according to a display panel/display resolution in a destination scaler before displaying it on a screen.

Regarding CAC, a perfect lens may not have chromatic/color aberration. That is, when light passes through a perfect lens, all color components reach the screen at the same point. Yet, practical lenses have limitations due to variations in refractive indexes for different colors, and thus colors fall at different points on the screen, which results in a viewer seeing color aberration on the screen. In some instances, this may cause the image to look blurred. Generally, the green color remains unaffected by color aberration, but color aberration affects the red and blue colors, which are diffracted on opposite sides of the green color. To correct such aberrations and blurring, CAC may be applied for the aberrations via image processing before the passing of the image to the lens (e.g., a pre-processing image correction algorithm(s) in an application processor that may be performed in a digital domain and that includes an inverse function of the aberration to correct or adjust image blurring from lens refraction), or by using a color corrected lens with the lens, in order to nullify the effect of lens distortion and provide a clear image to the eye of the user(s). CAC may split/divide an image into color components (e.g., red (R), green (G), blue (B)) by a CAC splitter/divider, resulting in a data format that may be utilized by lower-level pipelines (e.g., ViG, DMA, etc.). Because green (G) remains unaffected by aberration, green (G) may bypass CAC operations in ViG pipelines and pass through the DMA pipeline, while red (R) and blue (B) are processed through the ViG pipelines for CAC operations and subsequently through blending of red (R), green (G), blue (B) by an LM(s).

In an example, a pixel processing architecture, (e.g., for an XR device), may support foveated blending through four ViG pipelines and two DMA pipelines, while CAC is supported by the four ViG pipelines and two additional DMA pipelines (e.g., four total DMA pipelines). In other words, both operations for foveated blending and operations for CAC are performed in the ViG pipeline, which supports a single operation at one time. Thus, resources and architectures of such an architecture may be constrained and may not be able to perform foveated blending and CAC together, e.g., concurrently prior to outputting image data to a memory, display panel, display, etc., based on such constraints. Additionally, when DE is performed on image data after CAC operations, the efficacy of the CAC operations is reduced, which results in color aberration artifacts and blurring, and such an architecture is constrained from utilizing DE effectively to enhance image sharpness/crispness.

Foveated blending and CAC may both use the ViG pipeline(s), which may support a single operation at a time. Aspects herein provide for additional ViG pipelines and DMA pipelines in a display processing hardware architecture. The output of the foveation blending may be provided for DE and then looped-back to a CAC splitter/divider for performance of CAC. In aspects, the loopback may be utilized instead of storing in memory (e.g., in doubled data rate (DDR) memory as used initially in some example CAC architectures), which eliminates a memory access and associated hardware from the DMA pipeline. Various technologies pertaining to concurrent pixel processing with late stage CAC and anti-aging correction are described herein. In an example, an apparatus (e.g., a display processor) blends a first portion of image data (e.g., a fovea region) and a second portion of image data (e.g., a periphery region) in accordance with foveated blending to generate blended image data. The apparatus enhances detail of the blended image data in accordance with a DE. The apparatus also adjusts the blended image data in accordance with CAC to generate adjusted blended image data, e.g., subsequent to the enhancement. The apparatus further outputs the adjusted blended image data for a display panel. In aspects, the apparatus corrects the blended image data for aging, before or after performing CAC, by at least one of SPR or demura. Accordingly, based on an architecture with eight ViG pipelines and six DMA pipelines where resources are divided between the two operations for foveated blending and CAC for concurrent performance, the output of the foveated blending is provided for DE prior to looping-back for performance of CAC and flexible aging correction, after which the blended, enhanced, and adjusted image data may be output to a display.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

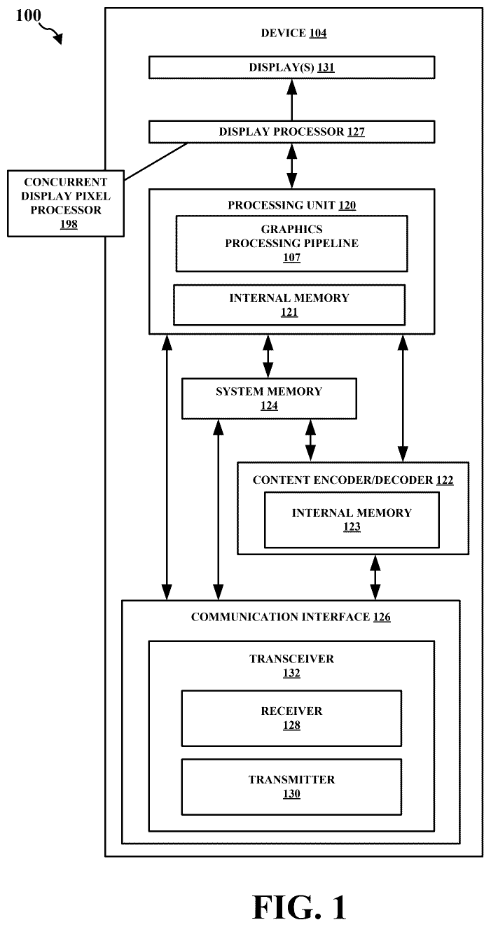

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a concurrent display pixel processor 198 configured to blend a first portion of image data and a second portion of image data in accordance with foveated blending to generate blended image data, to adjust the blended image data in accordance with CAC to generate adjusted blended image data, and to output the adjusted blended image data for a display panel. The concurrent display pixel processor 198 may also be configured to enhance detail of the blended image data in accordance with a DE, where to adjust the blended image data, the concurrent display pixel processor 198 may also be configured to adjust the blended image data subsequent to the enhancement of the detail of the blended image data. The concurrent display pixel processor 198 may also be configured to correct the blended image data for aging by at least one of sub-pixel rendering (SPR) or demura. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

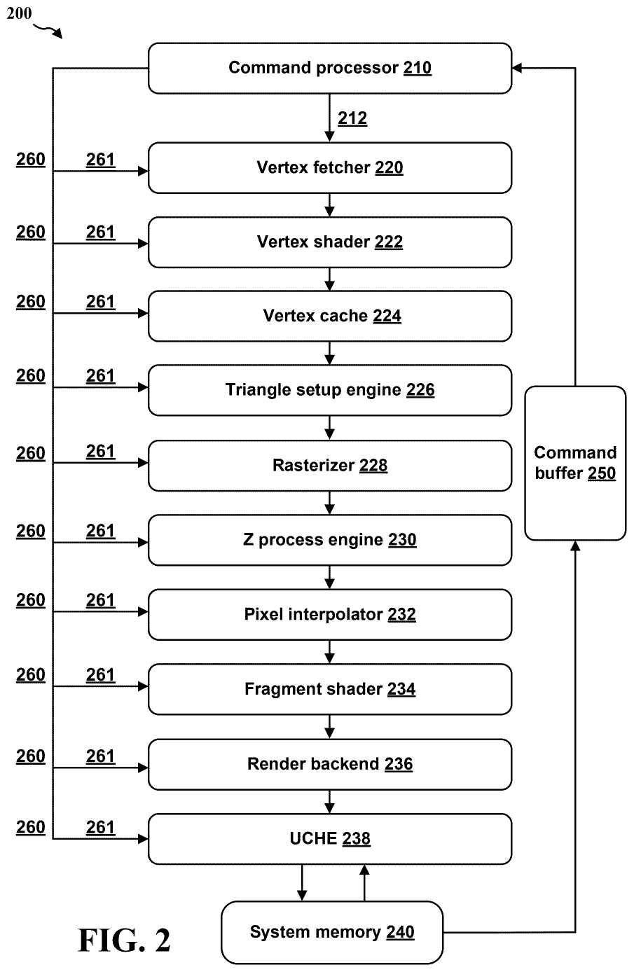

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

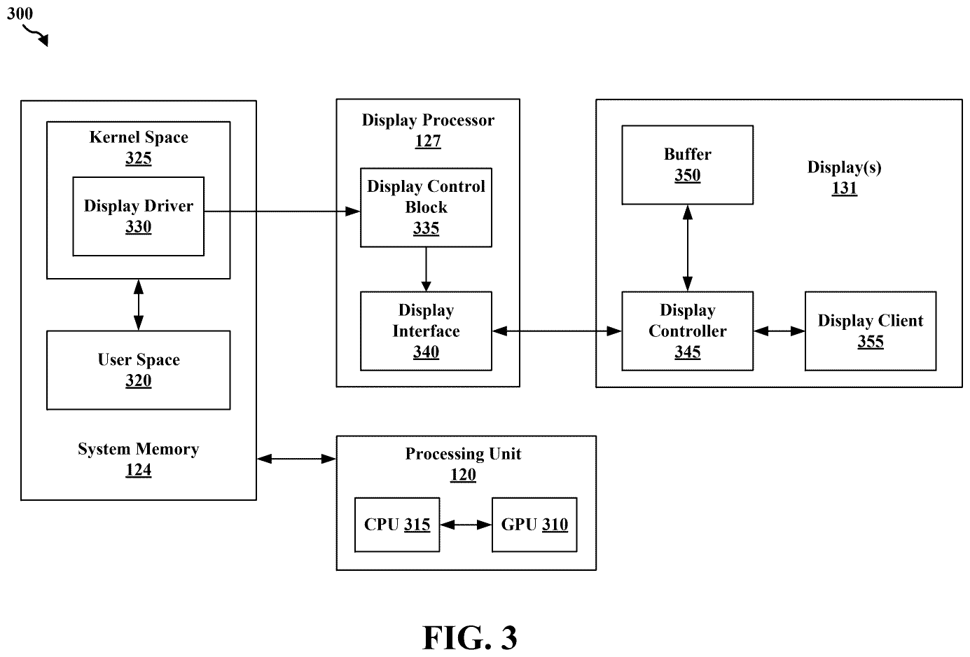

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

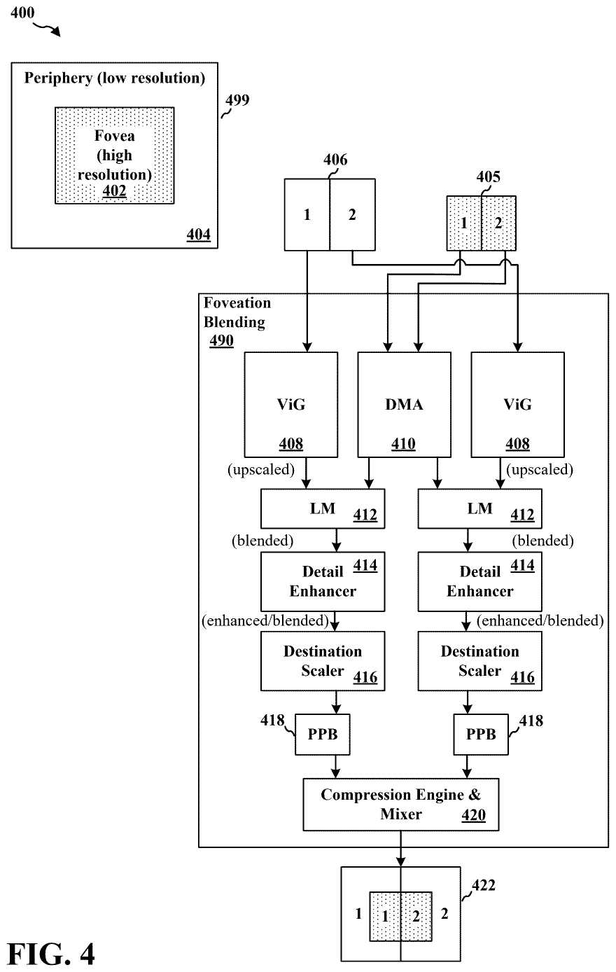

FIG. 4 is a diagram 400 illustrating foveated blending of image data portions. Diagram 400 is shown with an instance of foveation blending 490 for an image 499 with a fovea region 402 (e.g., high resolution) and a periphery region 404 (e.g., lower resolution). For foveated blending of the image 499, a first region/portion of image data 405 may include the fovea region 402, while a second region/portion of the image data 406 may include the periphery region 404. In aspects, the periphery region 404 may include lower resolution data for the entirety of the image 499, and part of this lower resolution data may be visible to the viewer via the periphery region 404 (e.g., where the fovea region 402 is not), and in some aspects, the fovea region 402 may not be centered in the image data, and thus, different parts/locations of the lower resolution periphery data of the periphery region 404 may be viewable at different times. Higher resolution fovea data of the fovea region 402 and lower resolution periphery data of the periphery region 404 may be separate data in the context of resolution for the image 499, while the periphery data of the image 499 may include portions of the image 499 that are provided at higher resolution in the fovea region 402 for viewing. The instance of foveation blending 490 includes two instances of a ViG pipeline 408, and accordingly, sub-portions (e.g., 1, 2) for the each of the first region/portion of image data 405 and the second region/portion of image data 406 may be processed in parallel to improve efficiency.

As noted herein, the first region/portion of image data 405 that includes the fovea region 402 may pass through a direct memory access (DMA) pipeline, e.g., an instance of a DMA pipeline 410 without ViG processing for upscaling. The two instances of the ViG pipeline 408 may perform upscaling for the sub-portions 1, 2 of the second region/portion of the image data 406 that includes the periphery region 404. After the upscaling and the pass-through, as noted above, the first region/portion of image data 405 and the second region/portion of image data 406 are passed to two instances of a layer mixer (LM) 412 in which blending of the first region/portion of the image data 405 and the second region/portion of the image data 406 is performed for composed blended image data of the sub-portions 1, 2. The blended image data of the sub-portions is respectively passed through two instances of a detail enhancement (DE) 414 to generate enhanced blended versions of the image data sub-portions, which are passed through instances of a destination scaler 416 where each is scaled according to a display panel resolution. Subsequent to the scaling, the image data sub-portions may be subject to post-processing buffering/storage by two instances of a ping-pong buffer (PPB) 418 prior to a compressing engine and mixer 420 that compresses and mixes the image data sub-portions as an output 422 to a display panel.

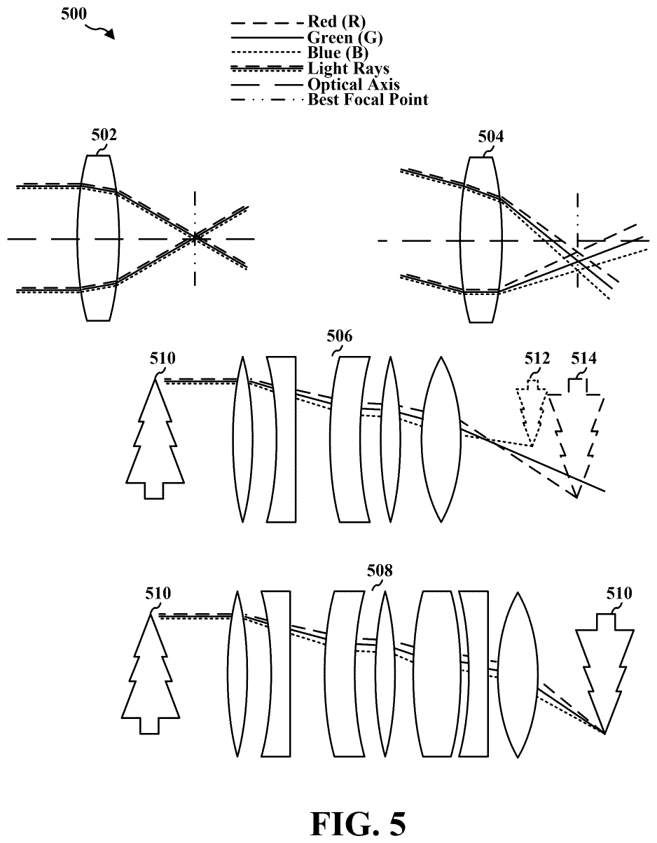

FIG. 5 is a diagram 500 illustrating color aberration and chromatic aberration correction (CAC) of images. Diagram 500 is shown in the context of a perfect lens 502 (with no chromatic aberration), a practical lens 504 (with lateral/transverse chromatic aberration), a standard lens 506, and a color corrected lens 508.

As illustrated, when light passes through the perfect lens 502, all color components reach a screen at the same focal point. In the practical lens 504, due to variation in refractive indexes for different colors, the colors will typically fall at different focal points on the screen, and a viewer sees color aberration at the screen causing the image to look blurred. Green color remains unaffected by the aberration, while red and blue colors are diffracted on opposite side of the green. These phenomena are shown another way for the standard lens 506 and the color corrected lens 508 with reference to an image 510. For example, the standard lens 506 passes diffracted light from the image 510, which results in aberration, e.g., a blue image 512 and a red image 514 which are off-center. In contrast, the color corrected lens 508 passes and corrects diffracted light from the image 510, which results in less or no aberration, e.g., rendering of the image 510. To correct color aberration when utilizing the standard lens 506, CAC may be applied for the aberration via image processing prior to passing the image/image data to the lens (e.g., a pre-processing image correction algorithm(s) in an application processor that may be performed in a digital domain and that includes an inverse function of the aberration to correct or adjust image blurring from lens refraction), or by using a color corrected lens with the lens, in order to nullify the effects of lens distortion and perceive clear images.

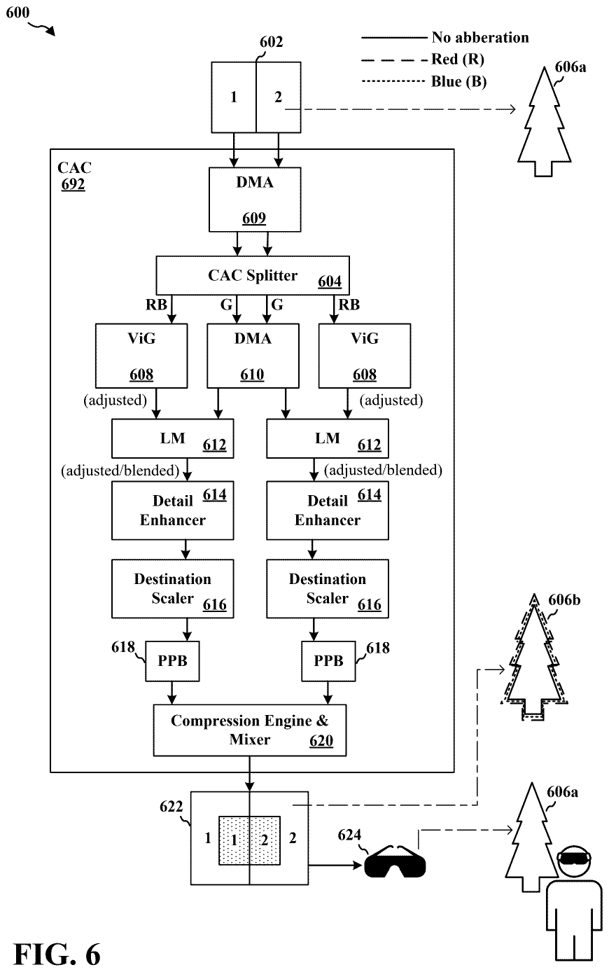

FIG. 6 is a diagram 600 illustrating CAC of images. Diagram 600 may be an implementation to correct color aberrations describe above for FIG. 5, and is shown in the context of CAC 692.

For example, input image data 602 of an image 606a with no aberration is provided through a DMA pipeline 609 and received by a CAC splitter 604 (also a CAC divider). Generally, for CAC, images are split/divided into red/green/blue (RGB) color components by a CAC splitter (e.g., the CAC splitter 604) to be in the format recognized lower-level pipelines. As green remains unaffected by aberration, it may skip a CAC operation and pass through a DMA pipeline 610. The sub-portions for the red and blue color image data that are output by the CAC splitter 604 may be respectively passed through instances of a ViG pipeline 608 for CAC operations. Subsequently, the adjusted red, green, and adjusted blue color image data for the sub-portions are provided to instances of an LM 612 for mixing, and to instances of a DE 614, a destination scaler 616, a PPB 618, and a compression engine and mixer 620, as similarly described above for FIG. 4, to generate an output 622 for a display panel (e.g., for a device 624, for the device 104, etc.). Unlike the description for FIG. 4, however, the output 622 may represent an inverse aberration image 606b, and when passed through a lens of the device 624/the device 104, color aberration of the lens may be canceled out via the inverse aberration image 606b (e.g., the color aberration and the inverse aberration may be combined to result in little/no aberration), and the image 606a may be rendered for viewing through the CAC 692 described above.

As noted herein, some example techniques for display processing may utilize single operations to for image improvement, such as foveated blending or CAC, but may not address concurrent operations. In such techniques, color aberration and blurring occurs due to processing limitations. In example display pixel processing architectures, such as those for XR, foveated blending and CAC are supported by ViG pipelines and DMA pipelines, yet ViG pipelines support a single operation at one time. Even when utilized in a dual-path implementation with two instances of the foveation blending 490 and the CAC 692 processing in parallel over additional sub-portions of image data to improve efficiency, some example solutions may not be enabled to perform foveated blending and CAC together, e.g., concurrently prior to outputting image data to a memory, panel, display, etc.

The aspects herein provide improved techniques for concurrent display pixel processing with detail enhancement prior to CAC such that image data is blended, enhanced, and adjusted with CAC prior to display.

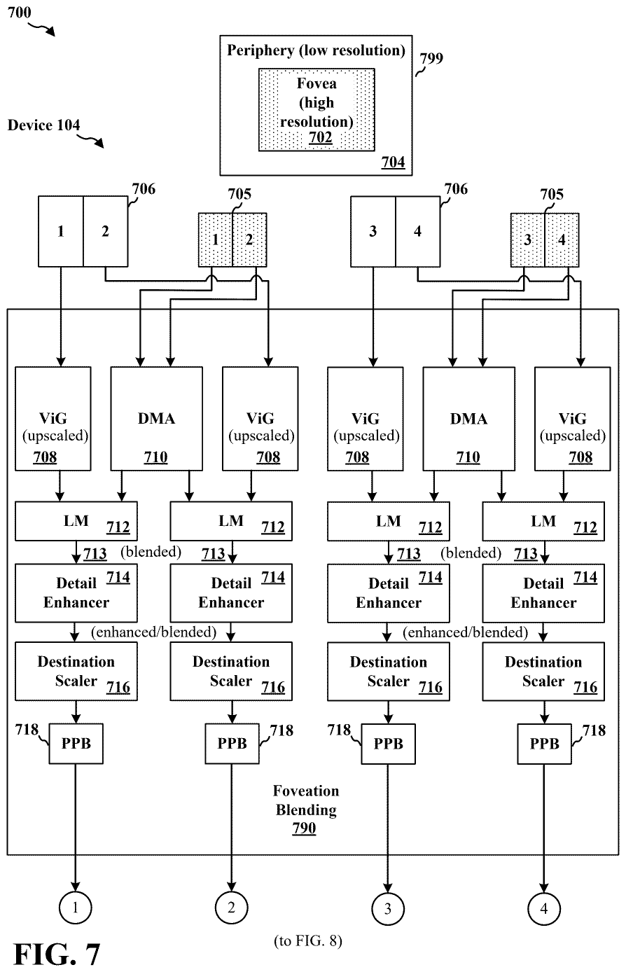

FIG. 7 is a diagram 700 illustrating dual-path foveated blending of image data portions for concurrent display pixel processing with late stage CAC based on/associated with one or more techniques of this disclosure. Diagram 700 shows foveation blending 790 for an image 799 with a fovea region 702 (e.g., high resolution) and a periphery region 704 (e.g., lower resolution). For foveated blending of the image 799, a first region/portion of image data 705 may include the fovea region 702, while a second region/portion of the image data 706 may include the periphery region 704.

The instance of foveation blending 790 includes four instances of a ViG pipeline 708 (e.g., 2× of two instances for the dual-path processing), and accordingly, sub-portions (e.g., 1, 2, 3, 4) for the each of the first region/portion of image data 705 and the second region/portion of image data 706 may be processed in parallel to further improve efficiency. Accordingly, the dual-path processing implementation is performed over four sub-portions of the first region/portion of image data 705 and the second region/portion of image data 706 (e.g., comprising the image 799).

As noted herein, the first region/portion of image data 705 that includes the fovea region 702 may pass through a DMA pipeline, e.g., two instances of a DMA pipeline 710 without ViG processing for upscaling. The four instances of the ViG pipeline 708 may perform upscaling for the sub-portions 1, 2, 3, 4 of the second region/portion of the image data 706 that includes the periphery region 704. After the upscaling and the pass-through, as noted above, the first region/portion of image data 705 and the second region/portion of image data 706 are passed to four instances of a LM 712 in which blending of the first region/portion of the image data 705 and the second region/portion of the image data 706 is performed for composed blended image data 713 of the sub-portions 1, 2, 3, 4. The blended image data 713 of the sub-portions 1, 2, 3, 4 is then respectively passed through four instances of a DE 714 to generate enhanced blended versions of the image data sub-portions (e.g., for crisper images), which are subsequently passed through four instances of a destination scaler 716 (e.g., each of the sub-portions 1, 2, 3, 4 for the first region/portion of the image data 705 and the second region/portion of the image data 706 is scaled according to a target display panel resolution). Subsequent to the scaling by the instances of the destination scaler 716, the image data sub-portions 1, 2, 3, 4 for the first region/portion of the image data 705 and the second region/portion of the image data 706 are subject to post-processing buffering/storage by four instances of a ping-pong buffer (PPB) 718.

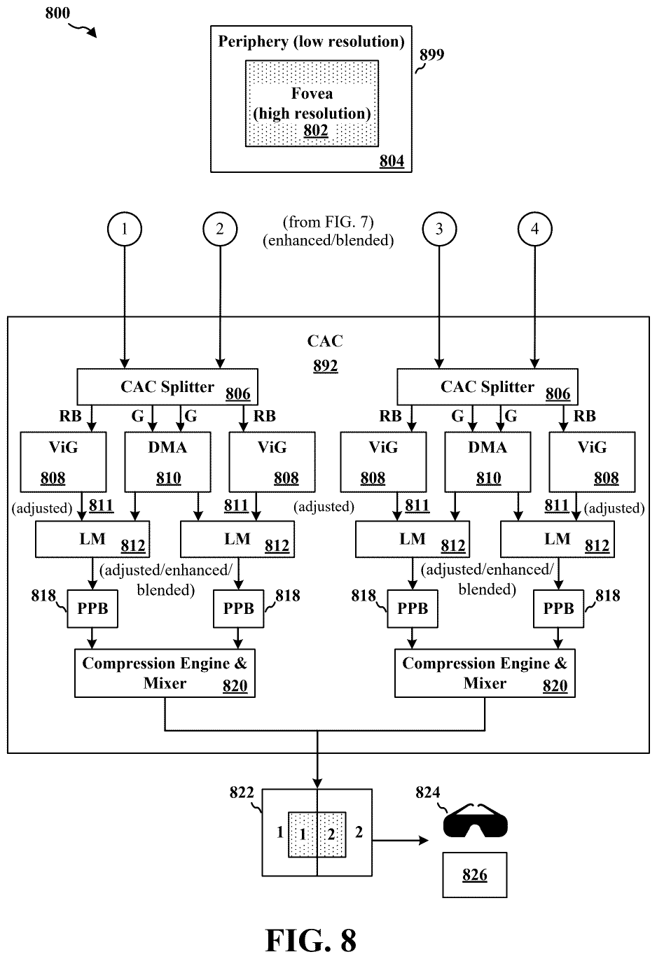

In contrast to the foveation blending 490 in FIG. 4, the foveation blending 790 in diagram 700 is an aspect for concurrent display pixel processing with late stage CAC. That is, the outputs (e.g., blended outputs) of the four instances of the PPB 718 are provided for further processing (e.g., looped back) via CAC (e.g., as continued in FIG. 8, described below) rather than being provided to a compression engine and mixer for output to a display panel.

FIG. 8 is a diagram 800 illustrating dual-path CAC of images with inputs from the dual-path foveated blending in FIG. 7 for concurrent display pixel processing with late stage CAC based on/associated with one or more techniques of this disclosure. Diagram 800 is shown in the context of CAC 892 that may be configured to correct color aberrations for the image data sub-portions 1, 2, 3, 4 for the first region/portion of the image data 705 and the second region/portion of the image data 706 associated with the image 799 (described above for FIG. 7; an image 899, with a fovea region 802 (e.g., high resolution) and a periphery region 804 (e.g., lower resolution), may be a continuing aspect of the image 799). As illustrated, and in contrast to the CAC 692 in FIG. 6, the CAC 892 in diagram 800 is an aspect for concurrent display pixel processing with late stage CAC. That is, the blended outputs of the four instances of the PPB 718 in FIG. 7, subsequent to the instances of the DE 714, are provided for further processing (e.g., looped back) to the CAC 892 (e.g., as continued in FIG. 8) rather than being provided to a compression engine and mixer for output to a display panel. That is, in some aspects, a display pipeline may be conceptualized as a division into two parts: (1) source processing (e.g., all ViG and DMA aspects) which may be prior to layer mixing by at least one LM (e.g., this processing may include fetching the layer(s) from instances of the DDR, unpacking, and performing scaling if required; and (2) destination processing (e.g., after the layer mixing), which may involve all post-processing operations, such as, but not limited to, those performed by detail enhancers, destination scalers, demura correction, SPR, and/or the like. The term “looped back” may refer to operations such as the data fetches from instance of the DDR that pass through the source processing block (e.g., ViG and DMA aspects) and then to digital-video-signal post-processing (DSPP) and feedback to the source processing block to perform the CAC 892 operations. In some aspects, the illustrated resources (e.g., ViG, DMA, etc.) in diagram 800 may be separate/additional, and distinct, resources from those depicted in diagram 700 in FIG. 7 (e.g., the ViG pipeline 708 in FIG. 7 may be separate and distinct from a ViG pipeline 808 in diagram 800 of FIG. 8).

For example, in the CAC 892, the image data for the blended outputs of the four instances of the PPB 718 in FIG. 7, blended and enhanced, is split/divided into red/green/blue (RGB) color components by a CAC splitter 806 (also a CAC divider) in order to be in the format recognized by lower-level pipelines of the CAC 892. As green remains unaffected by aberration, it may skip the CAC 892 operation processing and pass through instances a DMA pipeline 810 (e.g., two instances for the dual-path processing implementation). The color component portions of the image 899 data for the red and blue color image data that are output by the CAC splitter 806 may be respectively passed through instances of the ViG pipeline 808 for the CAC 892 operations. Subsequently, the adjusted red, green, and adjusted blue color for the image 899 data is provided to four instances of an LM 812 for mixing. Again in contrast to the implementation in FIG. 6 above, the mixed outputs of the four instances of the LM 812 in diagram 800 are passed to corresponding instances of a PPB 818 for post-processing buffering/storage rather than to a DE and destination scaler, as instances of the DE 714 and the destination scaler 716 have already performed such functions. Dual-path instances of a compression engine and mixer 820 receive the blended outputs of the PPB 818 instances that may be configured to compress and mix the image data sub-portions as an output 822, e.g., with an inverse aberration for the image 899 (e.g., via the CAC 892 operations), for a display panel 826 (e.g., of the device 104), for an XR device 824, etc.

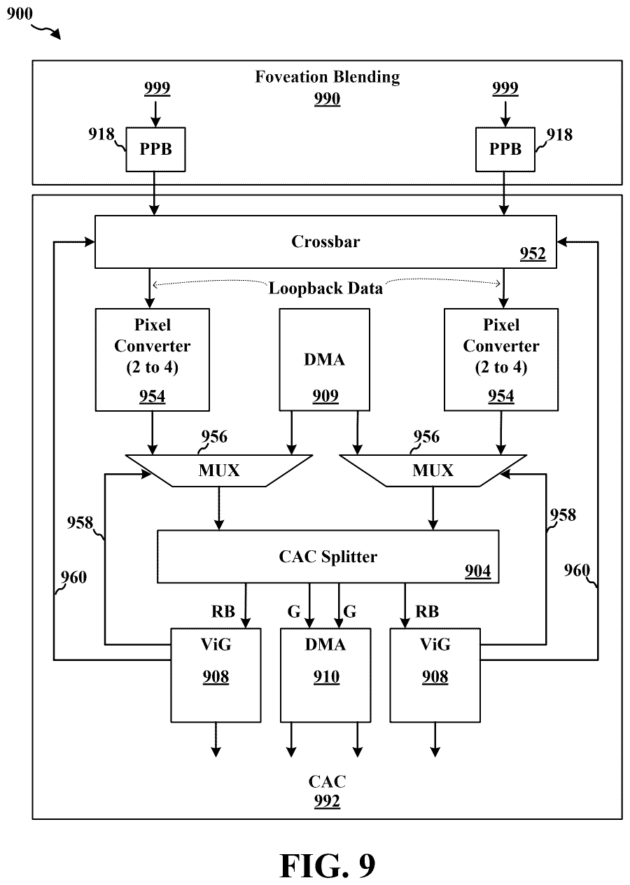

FIG. 9 is a diagram 900 illustrating an architecture for concurrent display pixel processing with late stage CAC based on/associated with one or more techniques of this disclosure. Diagram 900 may be an aspect of diagram 700 in FIG. 7 and/or diagram 800 in FIG. 8, and shows a portion of a foveation blending 990 (which may be an aspect of the foveation blending 790 in FIG. 7) and a CAC 992 (which may be an aspect of the CAC 892 in FIG. 8) for processing of image data 999. A single-path implementation for the foveation blending 990 and the CAC 992 is shown in diagram 900 for brevity and clarity of illustration, but aspects herein provide for dual-path implementations that include two instances of the foveation blending 990 and the CAC 992 (e.g., as described for FIGS. 7, 8 above).

As shown, the instances of a PPB 918 may be configured to generate post-processed outputs for the image data 999 that are output at a rate of two pixels per clock. A crossbar 952 may be configured to provide connections for the blended outputs of the PPB 918 instances to each instance of a pixel converter 954. The pixel converter 954 may be a 2-to-4 pixel converter configured to convert the post-processed outputs for the image data 999 at the rate of two pixels per clock to an output of pixel conversion image data, e.g., post-pixel converter image data, such as the output(s) of the pixel converter 954, that is at a rate of four pixels per clock, which may provide increased throughput based on utilization of processing capabilities associated with instances for a ViG pipeline 908 and a DMA pipeline 910, as shown in diagram 900.

The pixel conversion image data at the rate of four pixels per clock may pass to corresponding instances of a MUX 956 (e.g., a multiplexor) and to an instance of a CAC splitter 904 (also a CAC divider). In aspects, the instances of the MUX 956 may receive control inputs 958 from the corresponding instances of the ViG pipeline 908 in order to provide either loopback data 960 of image data from the corresponding instances of the ViG pipeline 908 or image data from an instance of the DMA pipeline 909 (e.g., for backward compatibility for other solutions). The CAC splitter 904 may be configured to split/divide image data inputs into red/green/blue (RGB) color components in order to be in the format recognized lower-level pipelines of the CAC 992. As green remains unaffected by aberration, it may skip the CAC 992 operation processing and pass through instances a DMA pipeline 910 (e.g., two instances for the dual-path processing implementation). The color component portions of the image data 999 for the red and blue color image data that are output by the CAC splitter 904 may be respectively passed through instances of the ViG pipeline 908 for the CAC 992 operations, as described herein.

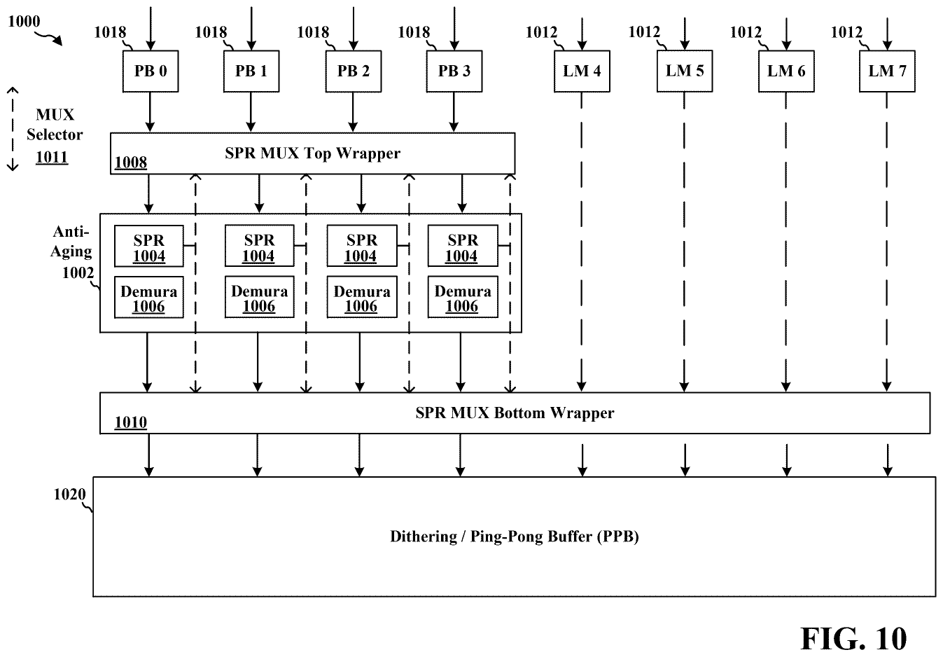

FIG. 10 is a diagram 1000 illustrating an architecture for concurrent display pixel processing with anti-aging and late stage CAC based on/associated with one or more techniques of this disclosure. Diagram 1000 may be an aspect of diagram 700 in FIG. 7, diagram 800 in FIG. 8, and/or diagram 900 in FIG. 9. Diagram 1000 is shown with respect to anti-aging correction 1002 prior to CAC.

In the example aspect for diagram 1000, the anti-aging correction 1002 is implemented after foveation blending, detail enhancement, and destination scaling, as described herein (e.g., from instances of a post-processing block (PB 1018)) and prior to CAC. In aspects, the anti-aging correction 1002 may be associated with SPR MUX wrappers controlled by a MUX selector 1011 for performing the anti-aging aspects. As one example, the image data may pass to an SPR MUX top wrapper 1008 from the instances of the PB 1018, and then pass to the anti-aging correction 1002. The anti-aging correction 1002 may include instances of SPR 1004 and/or instances of demura 1006 corresponding to instances of the PB 1018, and include anti-aging processing based on/associated with the instances of the SPR 1004 (e.g., configured to perform anti-aging sub-pixel rendering), in aspects, and/or based on/associated with instances of the demura 1006 (e.g., configured to perform anti-aging demura processing such as anti-burn-in/mura remediation). The outputs of the anti-aging correction 1002 may be passed to an SPR MUX bottom wrapper 1010, along with outputs of instances of an LM 1012, e.g., from subsequently performed CAC. After the SPR MUX bottom wrapper 1010, dithering/ping-pong operations 1020 may be performed, as shown.

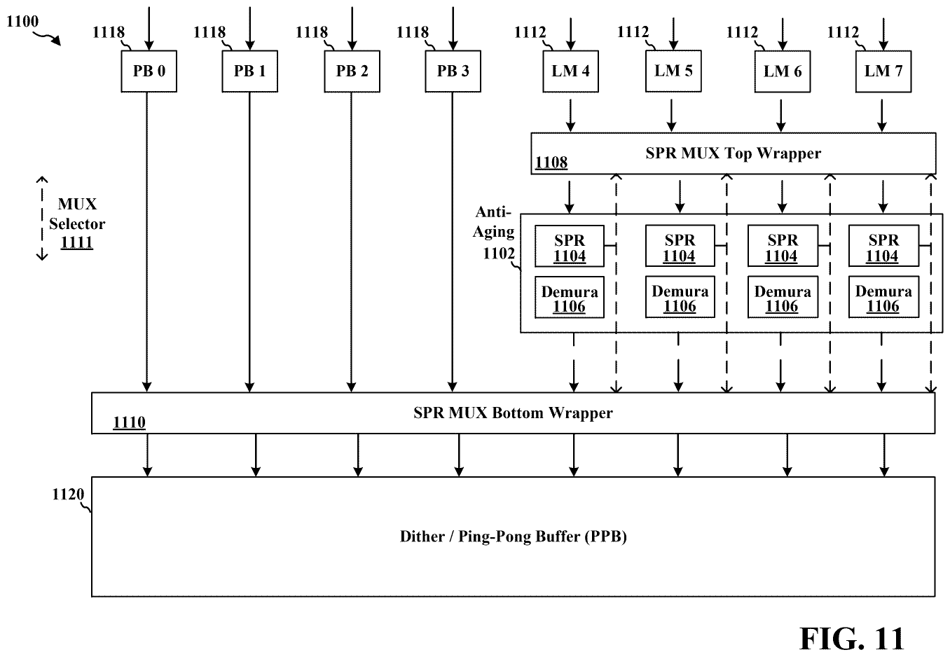

FIG. 11 is a diagram 1100 illustrating an architecture for concurrent display pixel processing with late stage CAC and anti-aging based on/associated with one or more techniques of this disclosure. Diagram 1100 may be an aspect of diagram 700 in FIG. 7, diagram 800 in FIG. 8, and/or diagram 900 in FIG. 9. Diagram 1100 is shown with respect to anti-aging correction 1102 prior to CAC for aspects that enable correcting blended image data for aging by at least one of SPR 1104 or demura 1106.

In the example aspect for diagram 1100, the anti-aging correction 1102 is implemented after foveation blending, detail enhancement, and destination scaling, as described herein (e.g., from instances of a post-processing block (PB 1118)) and after CAC (e.g., with blended, enhanced, and/or adjusted image data from instances of the LM 1112). In aspects, the anti-aging correction 1102 may be associated with SPR MUX wrappers controlled by a MUX selector 1111 for performing the anti-aging aspects. As one example, the image data may pass to an SPR MUX top wrapper 1108 from the instances of an LM 1112, and then pass to the anti-aging correction 1102. The anti-aging correction 1102 may include instances of SPR 1104 and/or instances of demura 1106 corresponding to instances of the LM 1112, and include anti-aging processing based on/associated with the instances of the SPR 1104 (e.g., configured to perform anti-aging sub-pixel rendering), in aspects, and/or based on/associated with instances of the demura 1106 (e.g., configured to perform anti-aging demura processing such as anti-burn-in/mura remediation). The outputs of the anti-aging correction 1102 may be passed to an SPR MUX bottom wrapper 1110, along with outputs of instances of a PB 1118, e.g., from previously performed foveated blending. After the SPR MUX bottom wrapper 1110, dithering/ping-pong operations 1120 may be performed, as shown.

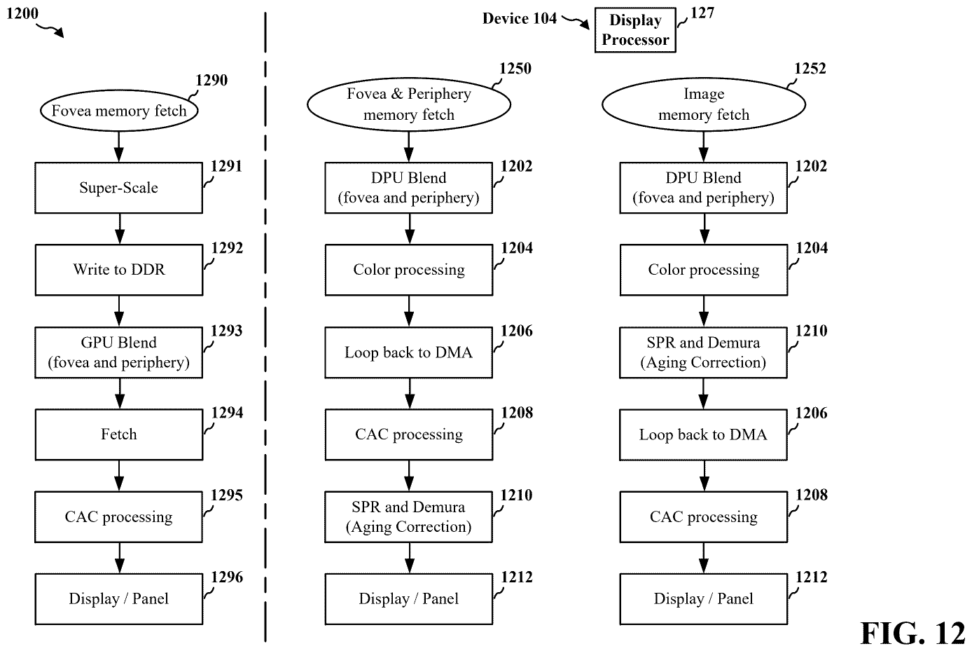

FIG. 12 is a diagram 1200 illustrating data flows for concurrent display pixel processing with late stage CAC and anti-aging in contrast to a data flow for non-concurrent display pixel processing based on/associated with one or more techniques of this disclosure. Portions of diagram 1200 may be aspects of the diagrams shown for, and described with respect to, FIGS. 7-11.

In some example solutions, an image processing flow may begin with a fovea memory fetch 1290, followed by a super-scale operation 1291 for the fetched data. The output of the super-scale operation 1291 may be written to DDR memory (at 1292), and subsequently, a GPU blending 1293 of fovea and periphery regions of the image data may be performed. The GPU blending 1293 may be followed by a fetch at 1294 for CAC processing 1295, prior to the image data being output for a display/panel 1296.

In contrast, aspects herein provide for two example data flows, as shown, which may be performed by the device 104, the display processor 127, and/or the concurrent display pixel processor 198.

One such example data flow for performance of anti-aging processing after CAC, may begin with a fovea and periphery image data memory fetch 1250. After the fovea and periphery image data memory fetch 1250, a display processing unit (DPU) blending 1202 for fovea and periphery image data, e.g., foveated blending as described for FIGS. 7-11, may be performed, followed by color processing 1204 (e.g., DE). In aspects, the outputs of the color processing 1204 may be looped-back to a DMA pipeline (at 1206), and CAC processing 1208, e.g., as described herein, may then be performed to adjust the image data. After the CAC processing 1208, SPR and Demura 1210 (e.g., anti-aging processing) may be performed on the adjusted image data output by the CAC processing 1208, and image data with blending, enhancement, anti-aging correction, and adjustment may thus be output to a display/panel 1212.

Another such example data flow for performance of anti-aging processing before CAC, may begin with an image data memory fetch 1252. After the image data memory fetch 1252, the DPU blending 1202 for fovea and periphery image data, e.g., foveated blending as described for FIGS. 7-11, may be performed, followed by the color processing 1204. In aspects, the outputs of the color processing 1204 (e.g., DE) may be processed for anti-aging correction utilizing the SPR and Demura 1210, prior to CAC. The image data with anti-aging correction may be output and looped-back to the DMA pipeline (at 1206), and the CAC processing 1208, e.g., as described herein, may then be performed to adjust the image data. The image data with blending, enhancement, anti-aging correction, and adjustment may thus be output to the display/panel 1212.

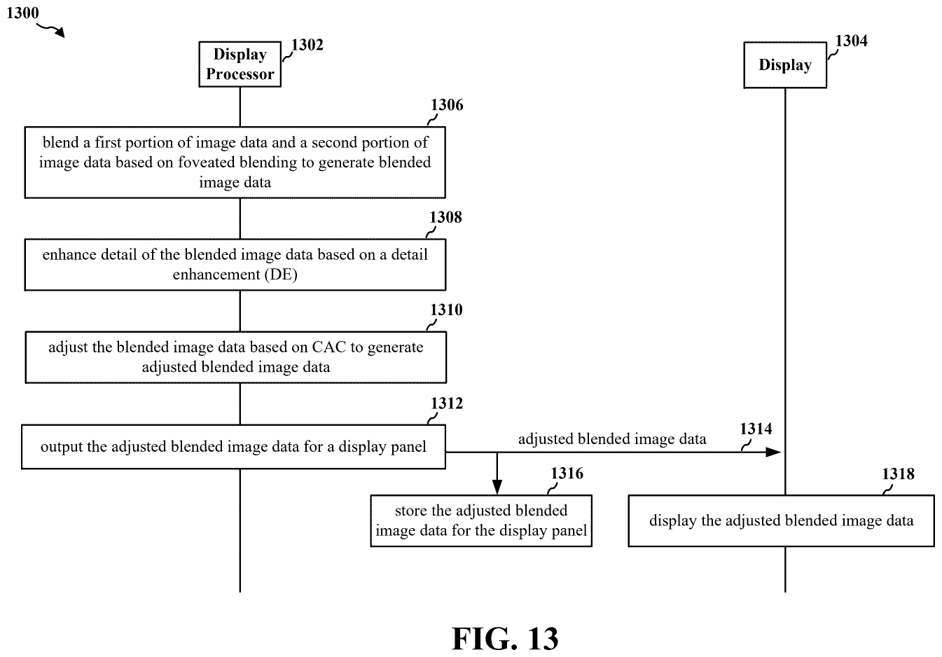

FIG. 13 is a call flow diagram 1300 illustrating example communications between a display processor 1302 and a display panel 1304 based on/associated with one or more techniques of this disclosure. In aspects, call flow diagram 1300 is described for concurrent display pixel processing with late stage CAC and anti-aging correction. In an example, the display processor 1302 may be or include the display processor 127. In an example, the display panel 1304 may be or include the display(s) 131.

At 1306, the display processor 1302 may be configured to blend a first portion of image data and a second portion of image data based on/associated with foveated blending to generate blended image data. In one example, to blend the first portion of image data, e.g., a fovea region, and the second portion of image data, e.g., a periphery region, based on/associated with the foveated blending, the display processor 1302 may be configured to generate the blended image data at an output of a PPB in association with a two-pixel per clock cycle rate. In aspects, the display processor 1302 may be configured to blend the first portion of image data and the second portion of image data based on/associated with foveated blending by utilizing a set of four ViG processing pipelines and two DMA pipelines.

At 1308, the display processor 1302 may be configured to enhance detail of the blended image data based on/associated with a DE. In aspects, the display processor 1302 may be configured to enhance detail of the blended image data via a DE prior to a CAC adjustment (e.g., at 1310) of the blended image data.

In aspects, the display processor 1302 may be configured to correct the blended image data for aging by at least one of SPR or demura. In some aspects, the display processor 1302 may be configured to correct the blended image data for aging subsequent to the enhancement (at 1308), via the DE, of the detail and prior to the adjustment (e.g., at 1310) based on/associated with CAC via looped-back data.

At 1310, the display processor 1302 may be configured to adjust the blended image data based on/associated with CAC to generate adjusted blended image data. The display processor 1302 may be configured to adjust the blended image data subsequent to the enhancement (e.g., at 1308) of the detail of the blended image data via the DE. In aspects, to adjust (e.g., at 1310) the blended image data based on/associated with the CAC, the display processor 1302 may be configured to receive the blended image data based on/associated with a pixel conversion subsequent to the output of the PPB via looped-back data. In such aspects, the pixel conversion may be associated with a conversion of the output of the PPB from the two-pixel per clock cycle rate to a four-pixel per clock cycle rate. In aspects, to receive the blended image data based on/associated with the pixel conversion, the display processor 1302 may be configured to select the blended image data based on/associated with a first selection option (e.g., based on a software indication via a software-configurable register). In such aspects, the first selection option may be associated with the adjustment (e.g., at 1310) of the blended image data being subsequent to a DE (e.g., the enhancement at 1308) of the blended image data. In some aspects, a second selection option may be associated with a reception of the blended image data based on/associated with a DMA. In aspects, to adjust (e.g., at 1310) the blended image data based on/associated with the CAC, the display processor 1302 may be configured to divide (e.g., or split) the blended image data based on/associated with the CAC and the four-pixel per clock cycle rate. In aspects, the display processor 1302 may be configured to adjust the blended image data based on/associated with the CAC by utilizing a set of four ViG processing pipelines and four DMA pipelines. In aspects, such ViG processing pipelines and DMA pipelines may be different than those described above for the foveated blending (e.g., at 1306).

In aspects, the display processor 1302 may be configured to correct the blended image data for aging by at least one of SPR or demura. In some aspects, the display processor 1302 may be configured to correct the blended image data for aging subsequent to the adjustment (at 1310) based on/associated with CAC via looped-back data, such as based on LM output of the CAC.

At 1312, the display processor 1302 may be configured to output the adjusted blended image data 1314 for the display panel 1304. In aspects, the adjusted blended image data 1314 may comprise a set of visual images. The output (at 1312) of the adjusted blended image data 1314 may include a transmission thereof for the display panel 1304 (e.g., as for example XR device implementations).

At 1316, the display processor 1302 may be configured to store the adjusted blended image data 1314 for the display panel 1304. The storage of the adjusted blended image data 1314 may be an aspect of the output (at 1312) thereof.

At 1318, the display panel 1304 may be configured to display the adjusted blended image data 1314. In some aspects, the display panel 1304 may be configured to display adjusted blended image data 1314 at the device 104. In some aspects, the display panel 1304 may be configured to display adjusted blended image data 1314 at an XR device.

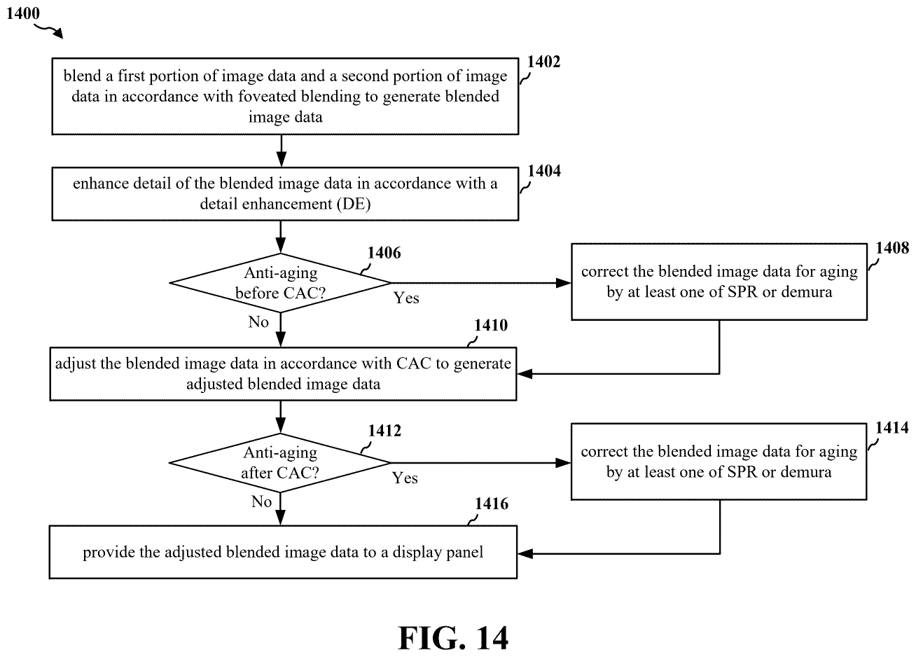

FIG. 14 is a flowchart 1400 of an example method of display processing based on/associated with one or more techniques of this disclosure. The method may be performed by an apparatus, such as an apparatus for display processing, a display processing unit (DPU) or other display processor (e.g., the display processor 127), a wireless communication device, and the like, as used in connection with the aspects of FIGS. 1-12. In an example, the method may be associated with concurrent display pixel processing with late stage CAC and anti-aging correction at a device (e.g., the device 104). In an example, the method may be performed by the concurrent display pixel processor 198.

At 1402, the apparatus (e.g., a display processor) blends a first portion of image data and a second portion of image data based on/associated with foveated blending to generate blended image data. For example, referring to FIG. 13, the display processor 1302 may be configured to blend (at 1306) a first portion (e.g., 702, 705 in FIG. 7; 802 in FIG. 8) of image data (e.g., 799 in FIG. 7; 899 in FIG. 8; 999 in FIG. 9) and a second portion (e.g., 704, 706 in FIG. 7; 804 in FIG. 8) of image data (e.g., 799 in FIG. 7; 899 in FIG. 8; 999 in FIG. 9) based on/associated with foveated blending (e.g., 790 in FIG. 7; 990 in FIG. 9; 1202 in FIG. 12) to generate blended image data (e.g., 713 in FIG. 7). In one example, to blend the first portion (e.g., 702, 705 in FIG. 7; 802 in FIG. 8) of image data (e.g., 799 in FIG. 7; 899 in FIG. 8; 999 in FIG. 9), e.g., a fovea region, and the second portion (e.g., 704, 706 in FIG. 7; 804 in FIG. 8) of image data (e.g., 799 in FIG. 7; 899 in FIG. 8; 999 in FIG. 9), e.g., a periphery region, based on/associated with the foveated blending (e.g., 790 in FIG. 7; 990 in FIG. 9; 1202 in FIG. 12), the display processor 1302 may be configured to generate the blended image data (e.g., 713 in FIG. 7) at an output of a PPB (e.g., 718 in FIG. 7; 918 in FIG. 9; 1020 in FIG. 10; 1120 in FIG. 11) in association with a two-pixel per clock cycle rate. In aspects, the display processor 1302 may be configured to blend the first portion (e.g., 702, 705 in FIG. 7; 802 in FIG. 8) of image data (e.g., 799 in FIG. 7; 899 in FIG. 8; 999 in FIG. 9) and the second portion (e.g., 704, 706 in FIG. 7; 804 in FIG. 8) of image data (e.g., 799 in FIG. 7; 899 in FIG. 8; 999 in FIG. 9) based on/associated with foveated blending (e.g., 790 in FIG. 7; 990 in FIG. 9; 1202 in FIG. 12) by utilizing a set of four ViG processing pipelines (e.g., 708 in FIG. 7) and two DMA pipelines (e.g., 710 in FIG. 7). In an example, 1402 may be performed by the concurrent display pixel processor 198.

At 1404, the apparatus (e.g., a display processor) enhances detail of the blended image data based on/associated with a detail enhancement (DE). For example, referring to FIG. 13, the display processor 1302 may be configured to enhance detail (at 1308) of the blended image data (e.g., 713 in FIG. 7) based on/associated with a DE (e.g., 714 in FIG. 7). In aspects, the display processor 1302 may be configured to enhance detail (at 1308) of the blended image data (e.g., 713 in FIG. 7) via a DE (e.g., 714 in FIG. 7) prior to a CAC adjustment (e.g., at 1310) (e.g., 892 in FIG. 8; 992 in FIG. 8) of the blended image data (e.g., 713 in FIG. 7). In an example, 1404 may be performed by the concurrent display pixel processor 198.

At 1406, the apparatus (e.g., a display processor) determines if anti-aging is to be performed before CAC. If so, the flowchart 1400 continues to 1408 and then to 1410; if not, the flowchart 1400 continues to 1410. In an example, 1406 may be performed by the concurrent display pixel processor 198.

At 1408, the apparatus (e.g., a display processor) corrects the blended image data for aging by at least one of SPR or demura, e.g., prior to CAC). For example, referring to FIG. 13, the display processor 1302 may be configured to correct (e.g., 1002 in FIG. 10; 1102 in FIG. 11) the blended image data (e.g., 713 in FIG. 7) for aging by at least one of SPR (e.g., 1004 in FIG. 10; 1104 in FIG. 11) or demura (e.g., 1006 in FIG. 10; 1106 in FIG. 11). In some aspects, the display processor 1302 may be configured to correct (e.g., 1002 in FIG. 10) the blended image data (e.g., 713 in FIG. 7) for aging subsequent to the enhancement (at 1308) (e.g., 1018 in FIG. 10), via the DE (e.g., 714 in FIG. 7), of the detail and prior to the adjustment (e.g., at 1310) based on/associated with CAC (e.g., 892 in FIG. 8; 992 in FIG. 8) via looped-back data (e.g., 960 in FIG. 9). In an example, 1408 may be performed by the concurrent display pixel processor 198.

At 1410, the apparatus (e.g., a display processor) adjusts the blended image data based on/associated with CAC to generate adjusted blended image data. For example, referring to FIG. 13, the display processor 1302 may be configured to adjust (e.g., at 1310) the blended image data (e.g., 713 in FIG. 7) based on/associated with CAC (e.g., 892 in FIG. 8; 992 in FIG. 8) to generate adjusted blended image data (e.g., 811 in FIG. 8). The display processor 1302 may be configured to adjust (e.g., at 1310) the blended image data (e.g., 713 in FIG. 7) subsequent to the enhancement (e.g., at 1308), via the DE (e.g., 714 in FIG. 7), of the detail of the blended image data (e.g., 713 in FIG. 7). In aspects, to adjust (e.g., at 1310) the blended image data (e.g., 713 in FIG. 7) based on/associated with the CAC (e.g., 892 in FIG. 8; 992 in FIG. 8), the display processor 1302 may be configured to receive the blended image data (e.g., 713 in FIG. 7) based on/associated with a pixel conversion (e.g., 954 in FIG. 9) subsequent to the output of the PPB (e.g., 718 in FIG. 7; 918 in FIG. 9; 1020 in FIG. 10; 1120 in FIG. 11) via looped-back data (e.g., 960 in FIG. 9). In such aspects, the pixel conversion (e.g., 954 in FIG. 9) may be associated with a conversion of the output of the PPB (e.g., 718 in FIG. 7; 918 in FIG. 9; 1020 in FIG. 10; 1120 in FIG. 11) from the two-pixel per clock cycle rate to a four-pixel per clock cycle rate. In aspects, to receive the blended image data (e.g., 713 in FIG. 7) based on/associated with the pixel conversion (e.g., 954 in FIG. 9), the display processor 1302 may be configured to select the blended image data (e.g., 713 in FIG. 7) based on/associated with a first selection option (e.g., based on a software indication via a software-configurable register) (e.g., 956, 958 in FIG. 9; 1008, 1010, 1011 in FIG. 10; 1108, 1110, 1111 in FIG. 11). In such aspects, the first selection option (e.g., 956, 958 in FIG. 9; 1008, 1010, 1011 in FIG. 10; 1108, 1110, 1111 in FIG. 11) may be associated with the adjustment (e.g., at 1310) of the blended image data (e.g., 713 in FIG. 7) being subsequent to a DE (e.g., the enhancement at 1308) (e.g., 714 in FIG. 7) of the blended image data (e.g., 713 in FIG. 7). In some aspects, a second selection option (e.g., 956, 958 in FIG. 9; 1008, 1010, 1011 in FIG. 10; 1108, 1110, 1111 in FIG. 11) may be associated with a reception of the blended image data based on/associated with a DMA (e.g., 810 in FIG. 8; 909 in FIG. 9). In aspects, to adjust (e.g., at 1310) the blended image data based on/associated with the CAC (e.g., 892 in FIG. 8; 992 in FIG. 8), the display processor 1302 may be configured to divide (e.g., or split) (e.g., 904 in FIG. 9) the blended image data (e.g., 713 in FIG. 7) based on/associated with the CAC (e.g., 892 in FIG. 8; 992 in FIG. 8) and the four-pixel per clock cycle rate. In aspects, the display processor 1302 may be configured to adjust (e.g., at 1310) the blended image data (e.g., 713 in FIG. 7) based on/associated with the CAC (e.g., 892 in FIG. 8; 992 in FIG. 8) by utilizing a set of four ViG processing pipelines (e.g., 808 in FIG. 8; 908 in FIG. 9) and four DMA pipelines (e.g., 810 in FIG. 8; 909, 910 in FIG. 9). In aspects, such ViG processing pipelines (e.g., 808 in FIG. 8; 908 in FIG. 9) and DMA pipelines (e.g., 810 in FIG. 8; 909, 910 in FIG. 9) may be different than those described above for the foveated blending (e.g., at 1306) (e.g., 790 in FIG. 7; 990 in FIG. 9; 1202 in FIG. 12). In an example, 1410 may be performed by the concurrent display pixel processor 198.

At 1412, the apparatus (e.g., a display processor) determines if anti-aging is to be performed after CAC. If so, the flowchart 1400 continues to 1414 and then to 1416; if not, the flowchart 1400 continues to 1416. In an example, 1412 may be performed by the concurrent display pixel processor 198.

At 1414, the apparatus (e.g., a display processor) corrects the blended image data for aging by at least one of SPR or demura, e.g., subsequent to CAC). For example, referring to FIG. 13, the display processor 1302 may be configured to correct (e.g., 1002 in FIG. 10; 1102 in FIG. 11) the blended image data (e.g., 713 in FIG. 7) for aging by at least one of SPR (e.g., 1004 in FIG. 10; 1104 in FIG. 11) or demura (e.g., 1006 in FIG. 10; 1106 in FIG. 11). In some aspects, the display processor 1302 may be configured to correct (e.g., 1002 in FIG. 10; 1102 in FIG. 11) the blended image data (e.g., 713 in FIG. 7) for aging subsequent to the adjustment (at 1310) based on/associated with CAC (e.g., 892 in FIG. 8; 992 in FIG. 8) via looped-back data (e.g., 960 in FIG. 9), such as based on LM (e.g., 812 in FIG. 8; 1112 in FIG. 11) output of the CAC (e.g., 892 in FIG. 8; 992 in FIG. 8). In an example, 1414 may be performed by the concurrent display pixel processor 198.

At 1416, the apparatus (e.g., a display processor) provides the adjusted blended image data to a display panel. For example, referring to FIG. 13, the display processor 1302 may be configured to output (e.g., at 1312) (e.g., 822 in FIG. 8) the adjusted blended image data 1314 (e.g., 811 in FIG. 8) for the display panel 1304. In aspects, the adjusted blended image data 1314 (e.g., 811 in FIG. 8) may comprise a set of visual images. The output (at 1312) (e.g., 822 in FIG. 8) of the adjusted blended image data 1314 (e.g., 811 in FIG. 8) may include a transmission thereof for the display panel 1304 (e.g., as for example XR device implementations). The display processor 1302 may be configured to store (e.g., at 1316) the adjusted blended image data 1314 (e.g., 811 in FIG. 8) for the display panel 1304. The storage of the adjusted blended image data 1314 (e.g., 811 in FIG. 8) may be an aspect of the output (at 1312) (e.g., 822 in FIG. 8) thereof. The display panel 1304 may be configured to display the adjusted blended image data (e.g., 811 in FIG. 8) 1314. In some aspects, the display panel 1304 may be configured to display adjusted blended image data 1314 (e.g., 811 in FIG. 8) at the device 104. In some aspects, the display panel 1304 may be configured to display adjusted blended image data 1314 (e.g., 811 in FIG. 8) at an XR device (e.g., 824, 826 in FIG. 8). In an example, 1416 may be performed by the concurrent display pixel processor 198.

In configurations, a method or an apparatus for display processing is provided. The apparatus may be a display processor, a DPU, a CPU (or other central processor), a display driver integrated circuit (DDIC), an apparatus for display processing, and/or some other processor that may perform display processing. In aspects, the apparatus may be the display processor 127 within the device 104, or may be some other hardware within the device 104 or another device. The apparatus, e.g., display processor 127, may include means for blending a first portion of image data and a second portion of image data based on/associated with foveated blending to generate blended image data. The apparatus, e.g., display processor 127, may include means for adjusting the blended image data based on/associated with CAC to generate adjusted blended image data. The apparatus, e.g., display processor 127, may include means for outputting the adjusted blended image data for a display panel. The apparatus, e.g., display processor 127, may also include means for enhancing detail of the blended image data based on/associated with a DE. The apparatus, e.g., display processor 127, may also include means for correcting the blended image data for aging by at least one of SPR or demura (e.g., prior or subsequent to an adjustment of blended image data based on/associated with CAC).

The subject matter described herein may be implemented to realize one or more benefits or advantages. For instance, the described display processing techniques may be used by a display processor, a DPU, a CPU, a central processor, or some other processor that may perform display processing to implement the anti-aging recording described herein. This may also be accomplished at a low cost compared to other display processing techniques. Moreover, the display processing techniques herein may improve or speed up data processing or execution. Further, the display processing techniques herein may improve resource or data utilization and/or resource efficiency. Additionally, aspects of the present disclosure may utilize anti-aging recording techniques in order to improve memory bandwidth efficiency and/or increase processing speed at a display processor, a DPU, or a CPU.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method for display processing, comprising: a memory; and a processor coupled to the memory, wherein, based on information stored in the memory, the processor is configured to: blend a first portion of image data and a second portion of the image data based on foveated blending to generate blended image data; adjust the blended image data based on chromatic aberration correction (CAC) to generate adjusted blended image data; and output the adjusted blended image data for a display panel.

Aspect 2 is the method of aspect 1, wherein the processor is further configured to: enhance detail of the blended image data based on detail enhancement (DE); wherein to adjust the blended image data, the processor is configured to adjust the blended image data subsequent to the enhancement of the detail of the blended image data.
Aspect 3 is the method of any of aspects 1 and 2, wherein to blend the first portion of the image data and the second portion of the image data based on the foveated blending, the processor is configured to generate the blended image data as a blended output with a two-pixel per clock cycle rate.
Aspect 4 is the method of aspect 3, wherein to adjust the blended image data based on the CAC, the processor is configured to: obtain the blended image data based on a pixel conversion subsequent to the blended output, wherein the pixel conversion is associated with a conversion of the blended output from the two-pixel per clock cycle rate to a four-pixel per clock cycle rate; and divide the blended image data based on the CAC and the four-pixel per clock cycle rate.
Aspect 5 is the method of aspect 4, wherein to obtain the blended image data based on the pixel conversion, the processor is configured to: select the blended image data based on a first selection option, wherein the first selection option is associated with the adjustment of the blended image data being subsequent to detail enhancement (DE) of the blended image data; wherein a second selection option is associated with a reception of the blended image data based on a direct memory access (DMA).
Aspect 6 is the method of any of aspects 1 to 5, wherein to blend the first portion of the image data and the second portion of the image data based on the foveated blending, the processor is configured to blend with four video graphics (ViG) processing pipelines and two direct memory access (DMA) pipelines.
Aspect 7 is the method of any of aspects 1 to 6, wherein to adjust the blended image data based on the CAC, the processor is configured to adjust the blended image data with four video graphics (ViG) processing pipelines and four direct memory access (DMA) pipelines.
Aspect 8 is the method of any of aspects 1 to 7, wherein the first portion of the image data is associated with a fovea region and the second portion of the image data is associated with a periphery region.
Aspect 9 is the method of any of aspects 1 to 8, wherein the processor is further configured to: correct the blended image data for aging by at least one of sub-pixel rendering (SPR) or demura.
Aspect 10 is the method of aspect 9, wherein to correct the blended image data for the aging, the processor is configured to correct the blended image data for the aging prior to the adjustment of the blended image data.
Aspect 11 is the method of any of aspects 1 to 10, wherein the image data is associated with an extended reality (XR) application.
Aspect 12 is the method of any of aspects 1 to 11, wherein the method is performed by a wireless communication device.
Aspect 13 is the method of any of aspects 1 to 12, wherein to output the adjusted blended image data for the display panel, the processor is configured to: transmit the adjusted blended image data to the display panel; or store the adjusted blended image data for the display panel.
Aspect 14 is an apparatus for display processing comprising a processor coupled to a memory and, based on information stored in the memory, the processor is configured to implement a method as in any of aspects 1-13.
Aspect 15 may be combined with aspect 14 and comprises that the apparatus is a wireless communication device.
Aspect 16 is an apparatus for display processing comprising means for implementing a method as in any of aspects 1-13.
Aspect 17 is a computer-readable medium (e.g., a non-transitory computer readable-medium) storing computer executable code, the computer executable code, when executed by a processor, causes the processor to implement a method as in any of aspects 1-13.

Various aspects have been described herein. These and other aspects are within the scope of the following claims.

What is claimed is:

1. An apparatus for display processing, comprising:
a memory; and
a processor coupled to the memory, wherein, based on information stored in the memory, the processor is configured to:
blend a first portion of image data and a second portion of the image data based on foveated blending to generate blended image data;
adjust the blended image data based on chromatic aberration correction (CAC) to generate adjusted blended image data; and
output the adjusted blended image data for a display panel.

2. The apparatus of claim 1, wherein the processor is further configured to:
enhance detail of the blended image data based on detail enhancement (DE);
wherein to adjust the blended image data, the processor is configured to adjust the blended image data subsequent to the enhancement of the detail of the blended image data.

3. The apparatus of claim 1, wherein to blend the first portion of the image data and the second portion of the image data based on the foveated blending, the processor is configured to generate the blended image data as a blended output with a two-pixel per clock cycle rate.

4. The apparatus of claim 3, wherein to adjust the blended image data based on the CAC, the processor is configured to:
obtain the blended image data based on a pixel conversion subsequent to the blended output, wherein the pixel conversion is associated with a conversion of the blended output from the two-pixel per clock cycle rate to a four-pixel per clock cycle rate; and
divide the blended image data based on the CAC and the four-pixel per clock cycle rate.

5. The apparatus of claim 4, wherein to obtain the blended image data based on the pixel conversion, the processor is configured to:
select the blended image data based on a first selection option, wherein the first selection option is associated with the adjustment of the blended image data being subsequent to detail enhancement (DE) of the blended image data;
wherein a second selection option is associated with a reception of the blended image data based on a direct memory access (DMA).

6. The apparatus of claim 1, wherein to blend the first portion of the image data and the second portion of the image data based on the foveated blending, the processor is configured to blend with four video graphics (ViG) processing pipelines and two direct memory access (DMA) pipelines.

7. The apparatus of claim 1, wherein to adjust the blended image data based on the CAC, the processor is configured to adjust the blended image data with four video graphics (ViG) processing pipelines and four direct memory access (DMA) pipelines.

8. The apparatus of claim 1, wherein the first portion of the image data is associated with a fovea region and the second portion of the image data is associated with a periphery region.

9. The apparatus of claim 1, wherein the processor is further configured to:
correct the blended image data for aging by at least one of sub-pixel rendering (SPR) or demura.

10. The apparatus of claim 9, wherein to correct the blended image data for the aging, the processor is configured to correct the blended image data for the aging prior to the adjustment of the blended image data.

11. The apparatus of claim 1, wherein the image data is associated with an extended reality (XR) application.

12. The apparatus of claim 1, wherein the apparatus is a wireless communication device.

13. The apparatus of claim 1, wherein to output the adjusted blended image data for the display panel, the processor is configured to:
transmit the adjusted blended image data to the display panel; or
store the adjusted blended image data for the display panel.

14. A method of display processing, comprising:
blending a first portion of image data and a second portion of image data based on foveated blending to generate blended image data;
adjusting the blended image data based on chromatic aberration correction (CAC) to generate adjusted blended image data; and
outputting the adjusted blended image data for a display panel.

15. The method of claim 14, further comprising:
enhancing detail of the blended image data based on detail enhancement (DE);
wherein adjusting the blended image data includes adjusting the blended image data subsequent to the enhancement of the detail of the blended image data.

16. The method of claim 14, wherein blending the first portion of image data and the second portion of image data based on the foveated blending includes generating the blended image data as an output with a two-pixel per clock cycle rate;
wherein adjusting the blended image data based on the CAC includes:
receiving the blended image data based on a pixel conversion subsequent to the blended output, wherein the pixel conversion is associated with a conversion of the blended output from the two-pixel per clock cycle rate to a four-pixel per clock cycle rate; and
dividing the blended image data based on the CAC and the four-pixel per clock cycle rate.

17. The method of claim 16, wherein receiving the blended image data based on the pixel conversion includes:
selecting the blended image data based on a first selection option, wherein the first selection option is associated with the adjustment of the blended image data being subsequent to detail enhancement (DE) of the blended image data;
wherein a second selection option is associated with a reception of the blended image data based on a direct memory access (DMA).

18. The method of claim 14, wherein blending the first portion of image data and the second portion of image data based on the foveated blending includes blending by a set of four video graphics (ViG) processing pipelines and two direct memory access (DMA) pipelines; or
wherein adjusting the blended image data based on the CAC includes adjusting the blended image data by the set of four ViG processing pipelines and four direct memory access (DMA) pipelines; or
wherein the first portion of the image data is associated with a fovea region and the second portion of the image data is associated with a periphery region.

19. The method of claim 14, further comprising correcting the blended image data for aging by at least one of sub-pixel rendering (SPR) or demura, wherein correcting the blended image data for the aging includes correcting the blended image data for the aging prior to or subsequent to the adjustment of the blended image data;
wherein the image data is associated with an extended reality (XR) application; or
wherein outputting the adjusted blended image data for the display panel comprises:
transmitting the adjusted blended image data to the display panel; or
storing the adjusted blended image data for the display panel.

20. A computer-readable medium storing computer executable code at a device, the code when executed by a processor causes the processor to:
blend a first portion of image data and a second portion of image data based on foveated blending to generate blended image data;
adjust the blended image data based on chromatic aberration correction (CAC) to generate adjusted blended image data; and
output the adjusted blended image data for a display panel.
